(19) United States
(12) Patent Application Publication
(10) Pub. No.: US 2013/0218779 A1
(43) Pub. Date: Aug. 22, 2013

(54) DUAL FACTOR DIGITAL CERTIFICATE SECURITY ALGORITHMS

(71) Applicants: Viacheslav Kirillin, Sankt-Petersburg (RU); Sergey Zemlyanskiy, Sankt-Petersburg (RU)

(72) Inventors: Viacheslav Kirillin, Sankt-Petersburg (RU); Sergey Zemlyanskiy, Sankt-Petersburg (RU)

(73) Assignee: Rawllin International Inc., Tortola, VI (US)

(21) Appl. No.: 13/401,719

(22) Filed: Feb. 21, 2012

(51) Int. Cl. G06Q 40/02; H04L 29/06; H04L 9/32

(52) U.S. Cl. 705/72; 705/35; 713/156

(57) ABSTRACT

Technologies are generally described for security algorithm methods in authorizing and using digital certificates to perform banking transactions. A customer can register and associate a personal identification number with a digital certificate. The personal identification number can be used by a client device to generate a certificate request. A request to perform a banking transaction along with a certificate request can be sent to a bank server, where, upon authorization of a valid certificate request, the banking operation can be performed. Using the digital certificate as one authentication factor and a customer login and password as a second authentication factor, banking transactions can be performed more reliably and securely.

### TECHNICAL FIELD

This application relates to banking, and more particularly to security algorithms associated with authorizing devices, activating devices, and performing bank operations using dual factor authenticated device authorization.

### BACKGROUND

Consumer and business demand for online services has greatly increased in recent years. This is also true in the banking industry where customers expect access to their accounts to both gather information and to perform banking operations. As the desire for online service has grown, so too has the number of internet connected devices. For example, some customers may have a computer at their place of occupation, a computer in a home office, a smart phone capable of connecting to the internet, a tablet computer, etc. Customer expectations are that they be able to access their accounts on any of the myriad of devices they may use to connect to internet services.

With customer expectations demanding multiple device connectivity, detecting fraudulent access to a customer's accounts becomes more complex. Creating an online hub for customers to access their accounts necessarily involves creating a public portal capable of granting a plurality of customers' access to their accounts. This public portal is also capable of being accessed by those without accounts such as those seeking to fraudulently access a customer's account. One way of preventing such fraudulent access is through restricting account access to authenticated users and restricting the performance of banking operations to those who have a valid digital certificate. However, protocols must be established to prevent improper registration of digital certificates.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to authenticated banking transactions. A communications component can at least one of send or receive data packets with a client device, a certificate authority, and a bank processing center, wherein data packets received from the client device include a bank operation request, a login information, and device authentication information. A certificate component can generate a certificate request. An encryption component can encrypt at least one of the bank operation request or the certificate request. A decryption component can decrypt at least one of a certificate or the login information. An authentication component can authenticate the bank operation request, the certificate, and the client device, wherein if the bank operation request, the login information, the certificate and the client device are all authenticated by the authentication component, the bank operation request is sent to the bank processing center by communications component.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates an example flow diagram method for registering a certificate to a activated client device;

FIG. 2 illustrates an example flow diagram method for registering a certificate to a non-activated client device;

FIG. 3 illustrates an example flow diagram method for performing a banking operation using dual factor digital certificate authentication;

FIG. 4 illustrates an example flow diagram method for dual factor digital certificate transactions;

FIG. 5 illustrates an example flow diagram method for registering a certificate to a device;

FIG. 6 illustrates an example secure banking system in accordance with the subject disclosure;

FIG. 7 illustrates an example client device in accordance with the subject disclosure

FIG. 8 illustrates an example schematic block diagram for a computing environment in accordance with the subject specification; and

FIG. 9 illustrates an example block diagram of a computer operable to execute the disclosed architecture.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

An algorithm of hash code generation can be used to generate a HASH, such as using the MD5 or SHA0-1 algorithms. Thus, a client device and a bank server can both calculate HASH independently of each other. Similarly, symmetric-key algorithms (“SYMM”) can be used where the encryption key is related to the decryption key. It can be appreciated that key generation can be uniform or adaptive in various implementations in the subject disclosure.

The architecture disclosure herein can be based on a multi-factor authentication process for banking operations. Operations can be performed over hyper text transfer protocol secure (“HTTPS”) which provides server authentication and data confidentiality between a client and a server. In the first factor, customers can be authenticated using a unique username and password. The authenticated customer can access personal data but cannot conduct banking operations.

In the second factor, banking operations can be carried out by an authenticated customer using digital certificates. A customer can activate a digital certificate that is associated with a personal identification number (“PIN”). The customer can submit the PIN along with a certificate request and a banking operation request to a bank server to perform the banking operation. The bank server can communicate with a certificate authority to verify the certificate request using the PIN. Upon verification, the bank server can use perform the requested banking operation. Thus, a customer must use a unique username and a password as a first factor and submit a PIN that can authorize a digital certificate request as a second factor to perform banking operations.

In one implementation, one time passwords can be generated and used to activate a client device to use digital certificates in accordance with various implementations in the subject disclosure. For example, a random string of letters and numbers can be generated by a password component. The password component can be adjusted by an administrator the like to adjust the types of characters used or length of a generated password. The password component can reside on a bank server and also generate RND upon request.

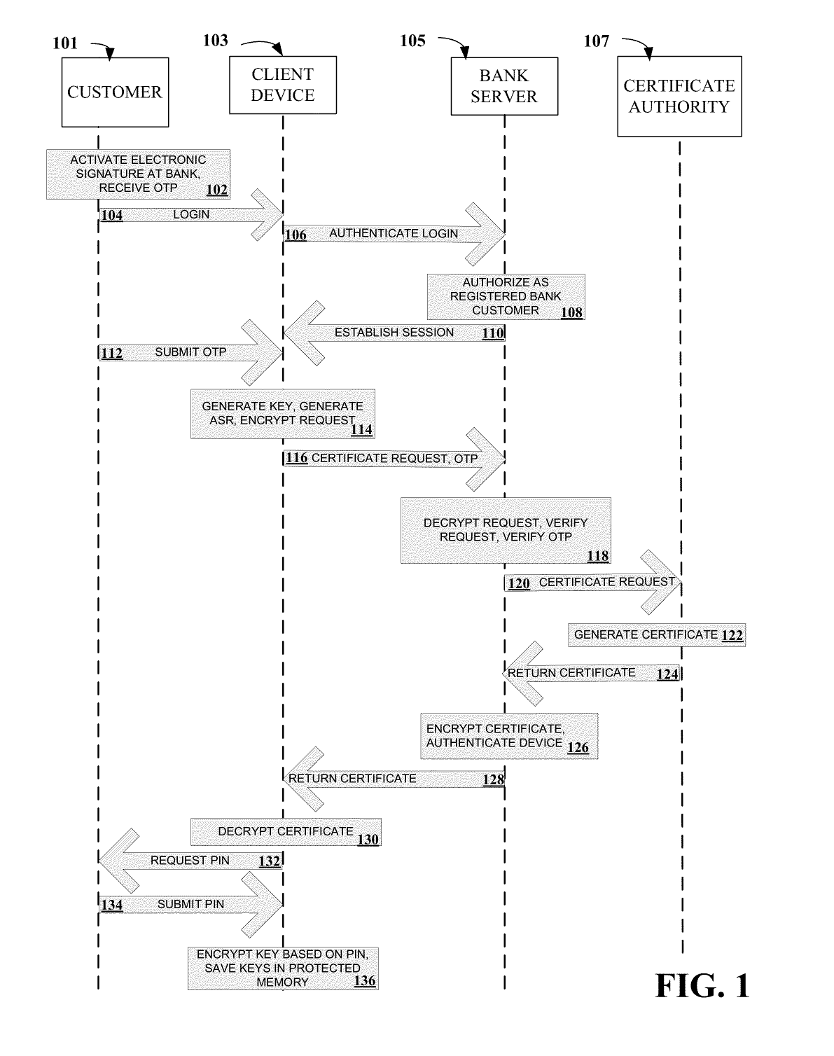

FIGS. 1-5 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Turning now to FIG. 1, there is illustrated an example flow diagram methodology for a customer activating a device certificate. At 102, customer 101 can activate an electronic signature at a bank location and receive a printed copy of an OTP. It can be appreciated that other methods of receiving a one time password are possible such as a customer receiving a letter, an e-mail, an SMS message or other communication that includes the OTP. At 104, customer 101 can submit login information to client device 103. Login information can include a username, password, phone number, security phrase, security question, etc. At 106, client device 103 can send to bank server 105 the submitted login information for authentication. At 108, bank server 105 can authorize customer 101 as a registered bank customer. At 110, a secure session can be established using a RND between client device 103 and bank server 105.

At 112, customer 101 can submit the OTP received at step 102 to client device 103. At 114, client device 103 can generate an SK, a certificate signing request and can calculate HASH and SYMM based off the SK. Client device 103 can further encrypt the certificate signing request and the OTP, using SYMM. At 116, client device 103 can send to bank server 105 the certificate by sending the encrypted message, HASH, SYMM, and the SUID associated with client device 103.

At 118, bank server 105 can calculate HASH and SYMM and verify the HASH received at 116 is valid, that client device 103 is not blocked, and that the client device is linked to customer 101. Bank server 105 can also decrypt the certificate signing request and OTP using SYMM.

At 120, bank server 105 can send the certificate signing request to certificate authority 107. It can be appreciated that certificate authority 107 can be a governmental agency or other agencies qualified by law to issue a signed certificate. At 122, certificate authority 107 can issue a signed certificate based on the certificate signing request. At 124, the signed certificate can be returned to bank server 105.

At 126, bank server 105 can encrypt the signed certificate using SYMM. Bank server 105 can also generate a RND to establish a secure session with 103. At 128, the encrypted signed certificate is returned to client device 103. At 130, the signed certificate is decrypted using SYMM. At 132, client device 103 can request customer 101 to enter a personal identification (“PIN”) number. At 134, customer 101 can submit a PIN for the electronic signature. At 136, customer security keys associated with client device 103 can be encrypted using a SYMM generated from the PIN submitted at 134 and saved in protected memory.

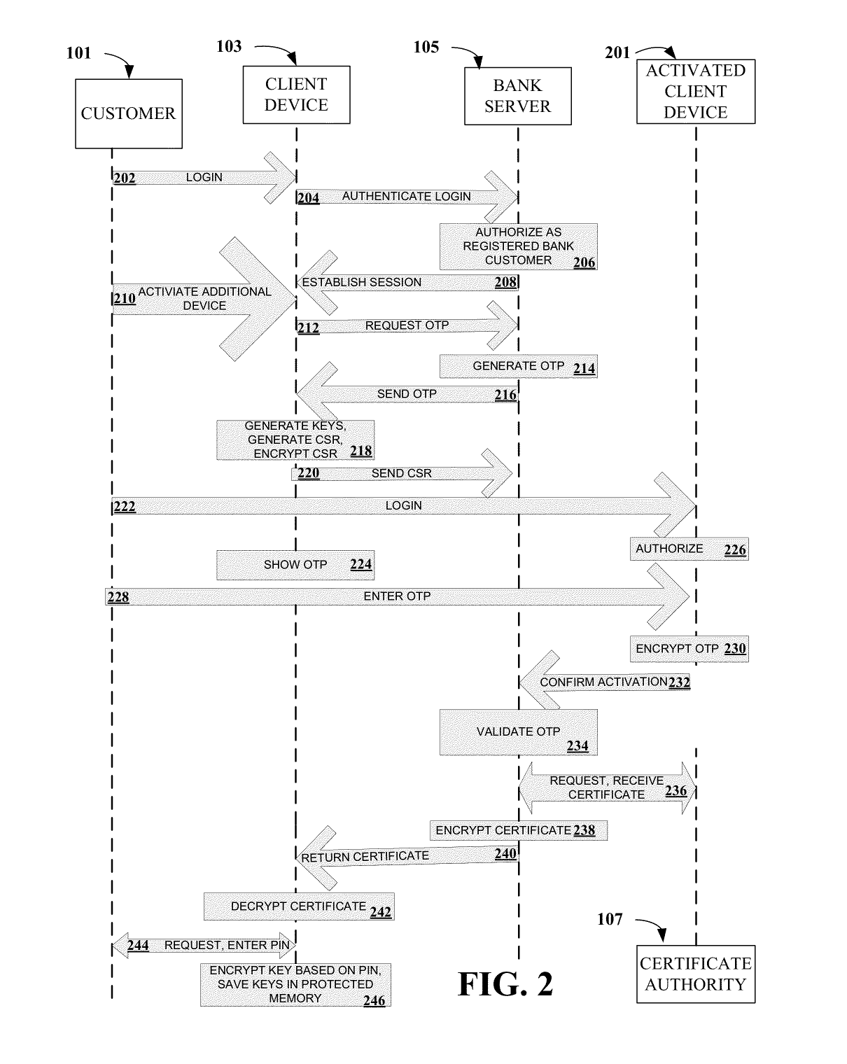

Turning now to FIG. 2, there is illustrated an example flow diagram methodology for a customer activating an additional device. At 202, customer 101 can submit login information to client device 103. Login information can include a username, password, phone number, security phrase, security question, etc. At 204, client device 103 can send to bank server 105 the submitted login information for authentication. At 206, bank server 105 can authorize customer 101 as a registered bank customer. At 208, a secure session can be established using a RND between client device 103 and bank server 105.

At 210, customer 101 can request to activate an additional device using client device 103. At 212, client device 103 can request a OTP from bank server 105. At 214, bank server 105 can generate a OTP and send it to client device 103 at 216.

At 218, client device 103 can encrypt a certificate signing request and the OTP using SYMM. Client device 103 can also generate an SUID associated with client device 103 and HASH. At 220, the SUID, HASH, and both the encrypted certificate signing request and encrypted OTP can be sent to bank server 105.

At 222, customer 101 can login to activated client device 201 using a login and password. At 224, client device 103 can display the OTP to customer 101. It can be appreciated that step 224 can occur before, simultaneously, or prior to steps 222 and 226 respectively. At 226, activated client device 201 can authorize customer 101 using the submitted username and password. At 228, customer 101 can enter the OTP and a PIN to activated client device 201. At 230, activated client device 201 can calculate HASH and SYMM, encrypt OTP using SYMM, and sign OTP against a client private key. At 232, SUID, HASH, the encrypted OTP, and the signed OTP can be sent to bank server 105 for confirmation.

At 234, bank server 105 can validate the client certificate received at 220 based upon information received at 232. At 236, bank server 105 can request a signed certificate from certificate authority 107 and receive a signed certificate from certificate authority 107 based on the request.

At 238, bank server 105 can encrypt the signed certificate using SYMM and generate a RND. At 240, bank server 105 can establish a secure session with client device 103 using the RND and send the encrypted signed certificate to client device 103. At 242, client device 103 can decrypt the signed certificate using SYMM. At 244, Client device 103 can request customer 101 submit a PIN and receive the submitted pin from customer 101. At 246, a customer SK can be encrypted using the SYMM generated from the PIN submitted at 244. The SK can be saved in protected device memory.

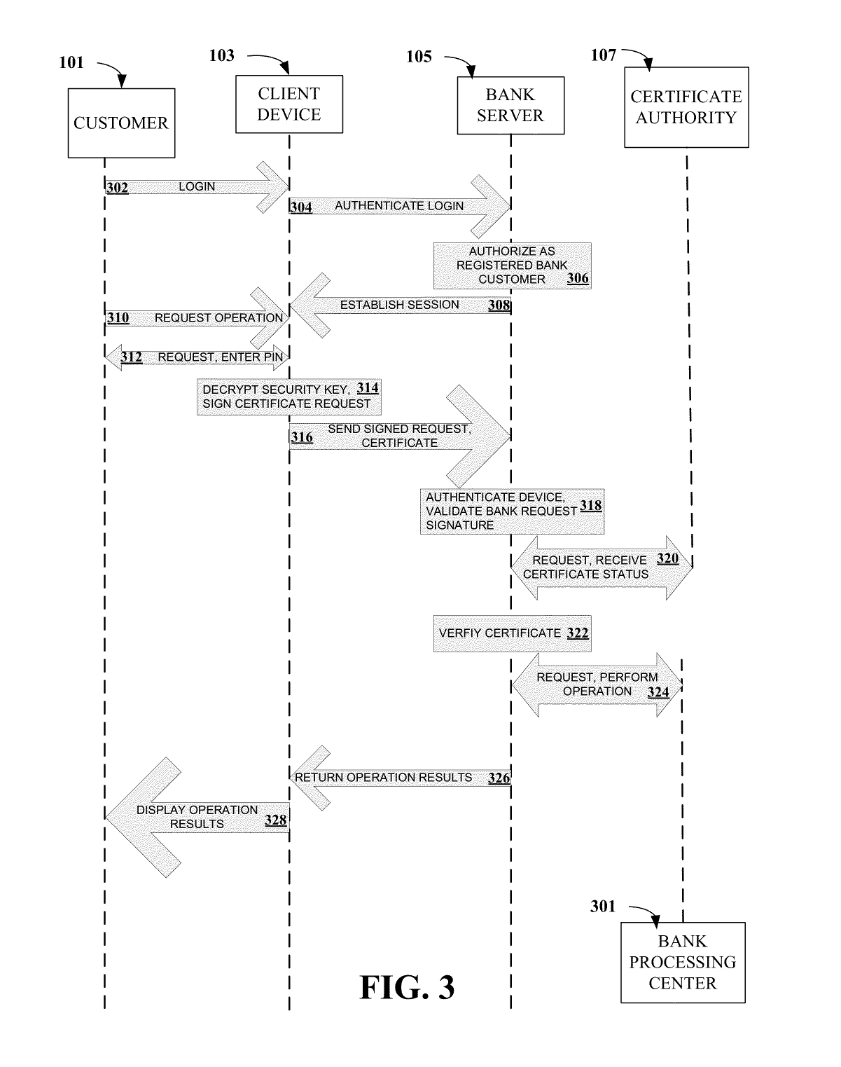

Turning now to FIG. 3, there is illustrated an example flow diagram methodology for a customer performing bank operations with a signature. At 302, customer 101 can submit login information to client device 103. Login information can include a username, password, phone number, security phrase, security question, etc. At 304, client device 103 can send to bank server 105 the submitted login information for authentication. At 306, bank server 105 can authorize customer 101 as a registered bank customer. At 308, a secure session can be established using a RND between client device 103 and bank server 105.

At 310, customer 101 can request performance of a bank operation wherein the bank operation can be at least one of a withdrawal, a deposit, a funds transfer, a bill payment, an account closing request, an account opening request, or a change to a customer profile associated with the customer. At 312, client device 103 can request and receive from customer 101 a PIN. At 314, customer 101 SK can be decrypted using the submitted PIN and the certificate request can be signed using the PIN.

At 316, client device 103 can send the bank request, SUID, HASH, and the signed certificate to bank server 105. At 318, bank server 105 can authenticate client device 103 based on the SUID and HASH. Bank server 105 can further validate the request for signature.

At 320, bank server 105 can request and receive a certificate status from certificate authority 107. At 322, bank server 105 can validate the certificate based on the certificate status. At 324, bank server 105 can request performance of the bank operation and receive a bank operation result based on the performance from bank processing center 301. At 326, bank server 105 can return the bank operation result. At 328, the operation result can be displayed to customer 101 using client device 103.

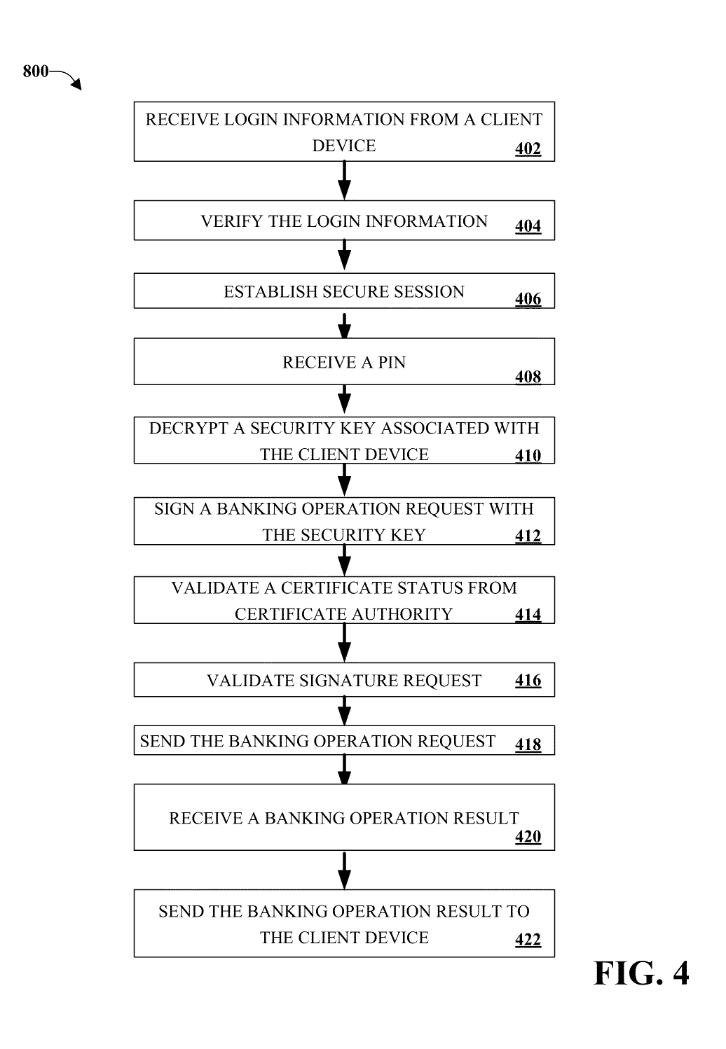

Referring now to FIG. 4, there is illustrated an example flow diagram method for dual factor digital certificate transactions. At 402, login information can be received from a client device associated with a customer. It can be appreciated that the client device can be at least one of a computer, a smart phone, a tablet, or an e-reader. At 404, the login information received from the client device can be verified for accuracy. At 406, a secure session can be established with the client device. In one embodiment, establishing a secure session is based upon a random generated number.

At 408, a PIN can be received from the customer. At 410, a security key associated with the client device can be decrypted based on the PIN. At 412, a banking operation request can be signed with the security key. At 414, a certificate status can be received from a certificate authority can be validated for accuracy. At 416, a signature request can validated for accuracy.

At 418, the banking operation request can be sent to a bank processing center. At 420, a banking operation result can be received from the bank processing center. At 422, the encrypted banking operation result can be sent to the client device.

In one embodiment, the method can further provide for decrypting the encrypted banking operation result based upon the symmetric key and displaying the banking operation result to the customer using the client device.

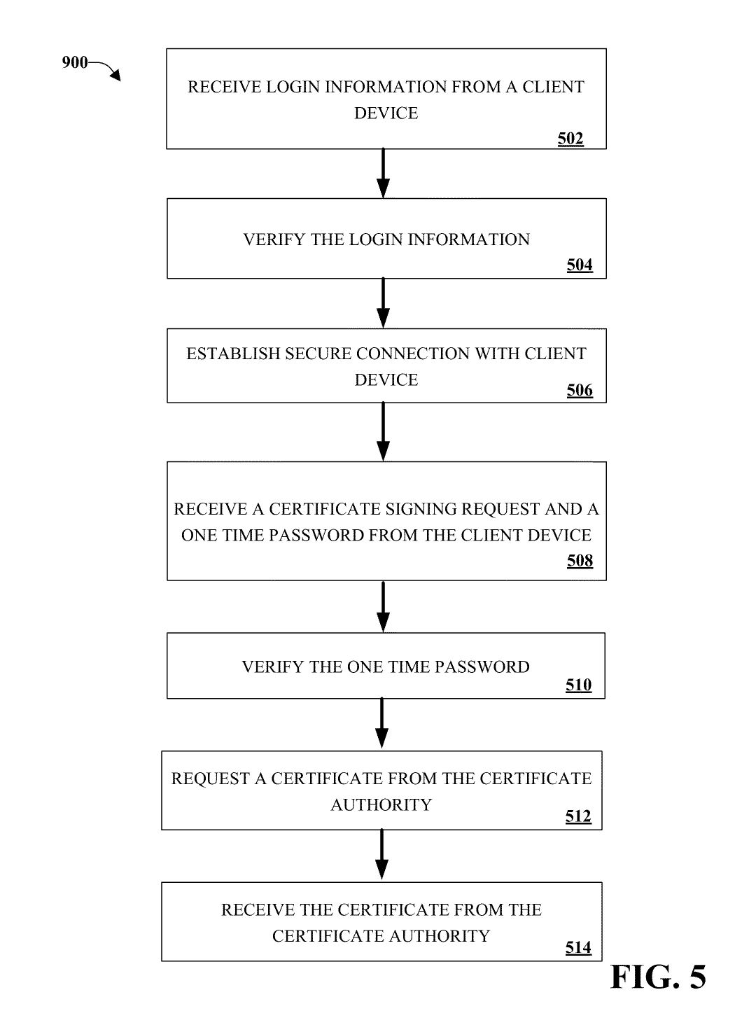

Referring now to FIG. 5, there is illustrated an example flow diagram method for registering a certificate to a device. At 502, login information can be received from a client device associated with a customer. At 504, the login information received from the client device can be verified for accuracy. At 506, a secure session can be established with the client device. In one embodiment establishing a secure session is based upon a random generated number.

At 508, a one-time password and a certificate signing request can be received from the client device. At 510, the one-time password can be verified for accuracy. At 512, a certificate can be requested from a certificate authority based on the certificate signing request. At 514, the certificate can be received from the certificate authority.

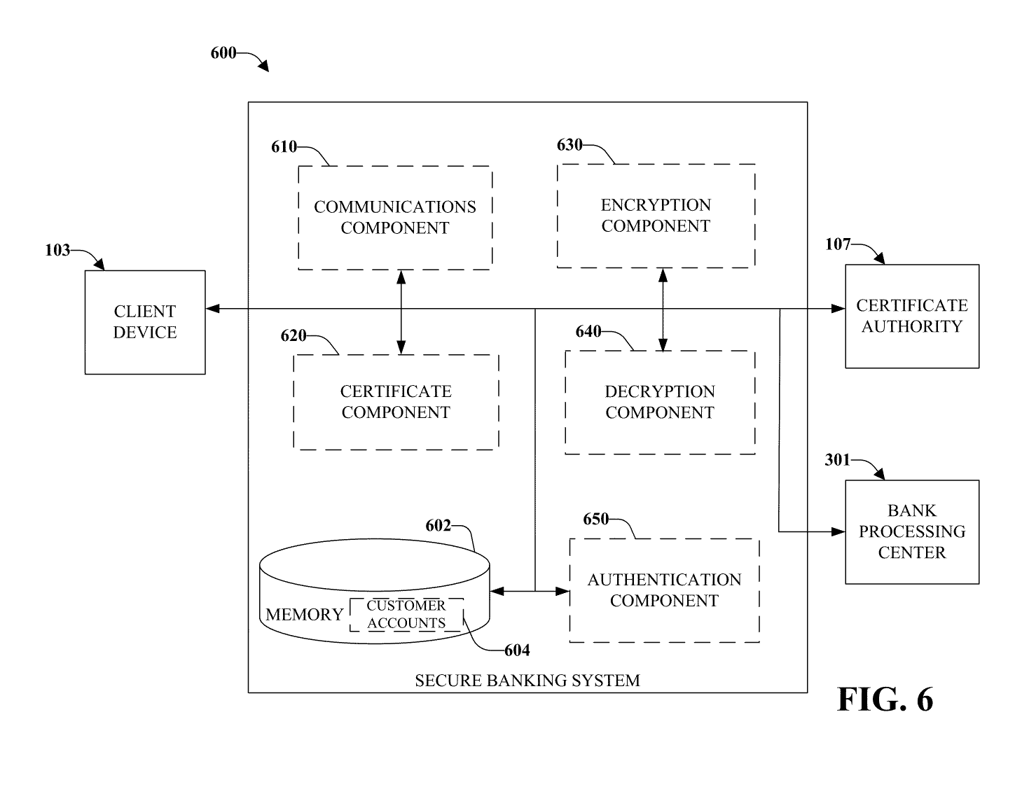

FIG. 6 illustrates an example secure banking system 600 in accordance with the subject disclosure. A communications component 610 can be configured to at least one of send or receive data packets with a client device, a certificate authority, and a bank processing center, wherein data packets received from the client device include a bank operation request, a login information, and device authentication information. In one embodiment the login information can contain a personal identification number. In one embodiment the device authentication information can include a security key associated with the device.

A certificate component 620 can be configured to generate a certificate request. An encryption component 630 can be configured to encrypt at least one of the bank operation request, the certificate request. A decryption component 640 can be configured to decrypt at least one of a certificate or the login information. An authentication component 650 can be configured to authenticate the bank operation request, the certificate, and the client device. It can be appreciated that the authentication component 650 can utilize customer accounts 604 stored in memory 602 in authenticating information.

In one embodiment, if the bank operation request, the login information, the certificate and the client device are all authenticated by the authentication component 650, the bank operation request can be sent to the bank processing center by communications component 610.

In one embodiment the communications component 610 can be further configured to receive a banking operation result from the bank processing center. The decryption component 640 can be further configured to decrypt the banking operation result. The encryption component 630 can be further configured to generate an encrypted banking operation result based upon the banking operation result. The communications component 610 can be further configured to send the encrypted banking operation result to the client device.

In one embodiment the authentication component 650 can be further configured to authenticate the bank operation request based upon the login information and the device authentication information.

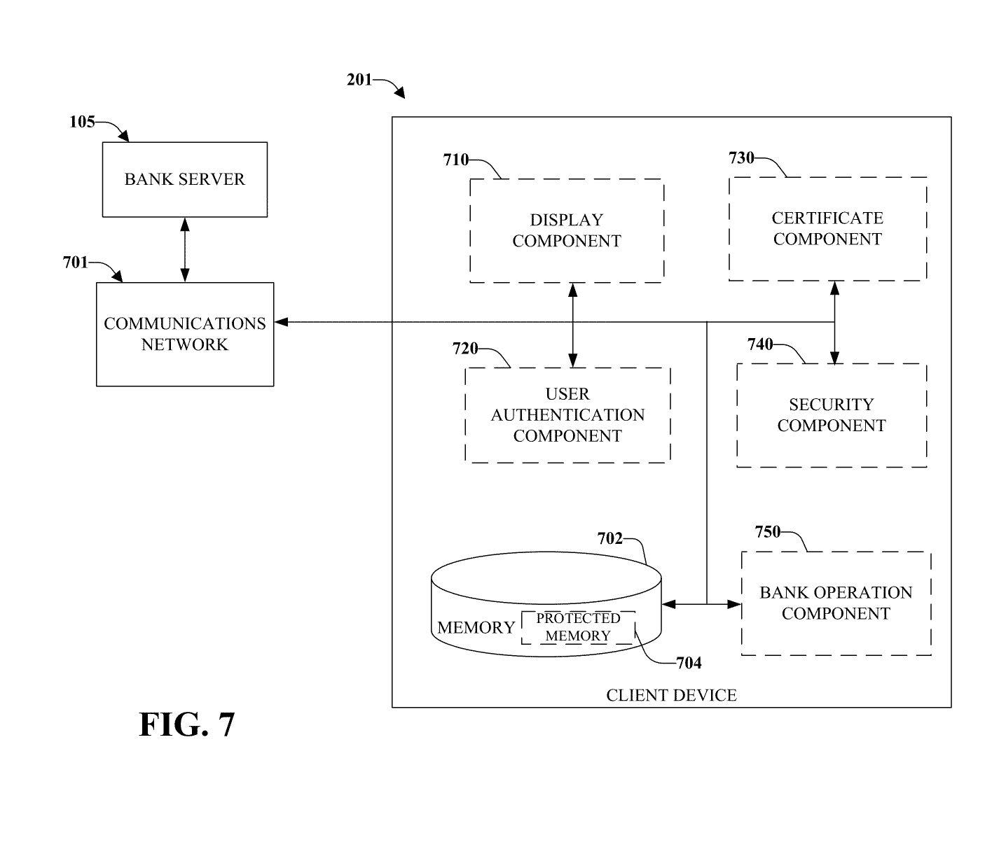

FIG. 7 illustrates an example client device 103 in accordance with the subject disclosure. A display component 710 can be configured to display a user request wherein the display component further receives a login information and a banking request from a user based on the user request. A user authentication component 720 can be configured to authenticate the user based upon sending the login information to a bank server using a communications network.

A security component 730 can be configured to store in protected memory 1104 a security key associated with the client device wherein the security component is further configured to generate an encrypted banking request based on the security key and the banking request. A bank operation component 740 can be configured to send the encrypted banking request to the bank server using the communications network. In one embodiment the bank operation component is further configured to receive an encrypted banking operation result. The security component 730 can be further configured to generate a decrypted banking operation result based on encrypted banking operation result and the security key. Display component 710 can be further configured to display the decrypted banking operation result.

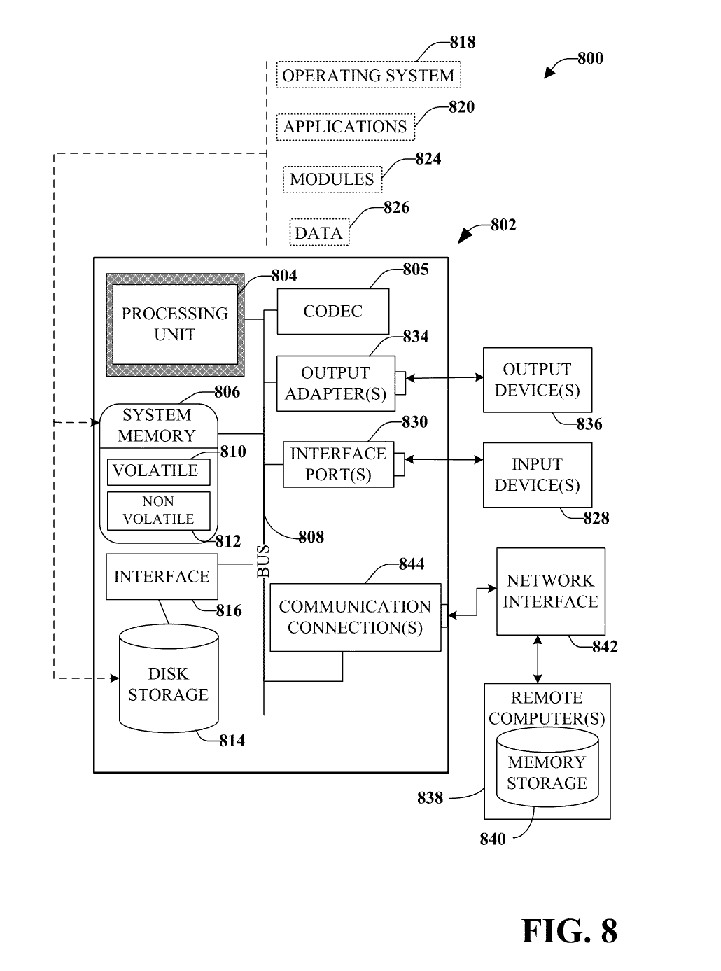

With reference to FIG. 8, a suitable environment 800 for implementing various aspects of the claimed subject matter includes a computer 802. The computer 802 includes a processing unit 804, a system memory 806, a codec 805, and a system bus 808. The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 806 includes volatile memory 810 and non-volatile memory 812. The basic input/output system (BIOS), containing the basic routines to transfer information between elements within the computer 802, such as during start-up, is stored in non-volatile memory 812. By way of illustration, and not limitation, non-volatile memory 812 can include read only memory (ROM), programmable ROM (PROM), electrically programmable ROM (EPROM), electrically erasable programmable ROM (EEPROM), or flash memory. Volatile memory 810 includes random access memory (RAM), which acts as external cache memory. According to present aspects, the volatile memory may store the write operation retry logic (not shown in FIG. 8) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 802 may also include removable/non-removable, volatile/non-volatile computer storage media. FIG. 8 illustrates, for example, a disk storage 814. Disk storage 814 includes, but is not limited to, devices like a magnetic disk drive, solid state disk (SSD) floppy disk drive, tape drive, Jaz drive, Zip drive, LS-100 drive, flash memory card, or memory stick. In addition, disk storage 814 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 814 to the system bus 808, a removable or non-removable interface is typically used, such as interface 816.

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer system 802. Applications 820 take advantage of the management of resources by operating system 818 through program modules 824, and program data 826, such as the boot/shutdown transaction table and the like, stored either in system memory 806 or on disk storage 814. It is to be appreciated that the claimed subject matter can be implemented with various operating systems or combinations of operating systems.

A user enters commands or information into the computer 802 through input device(s) 828. Input devices 828 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 804 through the system bus 808 via interface port(s) 830. Interface port(s) 830 include, for example, a serial port, a parallel port, a game port, and a universal serial bus (USB). Output device(s) 836 use some of the same type of ports as input device(s) 828. Thus, for example, a USB port may be used to provide input to computer 802, and to output information from computer 802 to an output device 836. Output adapter 834 is provided to illustrate that there are some output devices 836 like monitors, speakers, and printers, among other output devices 836, which require special adapters. The output adapters 834 include, by way of illustration and not limitation, video and sound cards that provide a means of connection between the output device 836 and the system bus 808. It should be noted that other devices and/or systems of devices provide both input and output capabilities such as remote computer(s) 838.

Computer 802 can operate in a networked environment using logical connections to one or more remote computers, such as remote computer(s) 838. The remote computer(s) 838 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 802. For purposes of brevity, only a memory storage device 840 is illustrated with remote computer(s) 838. Remote computer(s) 838 is logically connected to computer 802 through a network interface 842 and then connected via communication connection(s) 844. Network interface 842 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 844 refers to the hardware/software employed to connect the network interface 842 to the bus 808. While communication connection 844 is shown for illustrative clarity inside computer 802, it can also be external to computer 802. The hardware/software necessary for connection to the network interface 842 includes, for exemplary purposes only, internal and external technologies such as, modems including regular telephone grade modems, cable modems and DSL modems, ISDN adapters, and wired and wireless Ethernet cards, hubs, and routers.

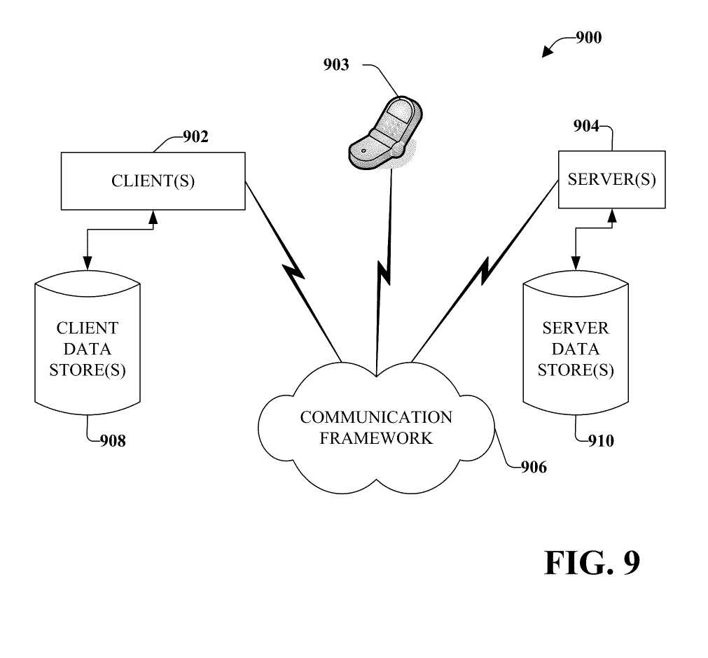

Referring now to FIG. 9, there is illustrated a schematic block diagram of a computing environment 900 in accordance with the subject specification. The system 900 includes one or more client(s) 902, which can include an application or a system that accesses a service on the server 904. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware or hardware in combination with software (e.g., threads, processes, computing devices). The servers 904 can house threads to perform, for example, encryption, decryption, calculations, etc. One possible communication between a client 902 and a server 904 can be in the form of a data packet adapted to be transmitted between two or more computer processes where the data packet contains, for example, a certificate. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A secure banking system comprising:
a memory that stores computer executable components; and
a processor that facilitates execution of computer executable components stored within the memory, the computer executable components, comprising:
a communications component that at least one of sends or receives data packets to or from a client device, a certificate authority, or a bank processing center, wherein received data packets received from the client device include a bank operation request, a login information, and device authentication information;
a certificate component that generates a certificate request;
an encryption component that encrypts at least one of the bank operation request or the certificate request;
a decryption component that decrypts at least one of a certificate or the login information; and
an authentication component that authenticates the bank operation request, the certificate, and the client device,
wherein if the bank operation request, the login information, the certificate and the client device are authenticated by the authentication component, the bank operation request is sent to the bank processing center by the communications component.

2. The secure banking system of claim 1, wherein the communications component further receives a banking operation result from the bank processing center.

3. The secure banking system of claim 2, wherein the decryption component further decrypts the banking operation result.

4. The secure banking system of claim 2, wherein the encryption component further generates an encrypted banking operation result based upon the banking operation result.

5. The secure banking system of claim 3, wherein the communications component further sends the encrypted banking operation result to the client device.

6. The secure banking system of claim 1, wherein the authentication component further authenticates the bank operation request based upon the login information and the device authentication information.

7. The secure banking system of claim 6, wherein the login information contains a personal identification number.

8. The secure banking system of claim 6, wherein the device authentication information includes a security key associated with the device.

9. A client device, comprising:
at least one memory that stores computer executable components; and
a processor that facilitates execution of one or more computer executable components stored within the memory, the one or more computer executable components comprising:
a display component that displays a user request wherein the display component further receives login information, a personal identification number (“PIN”), and a banking request from a user based on the user request;
a user authentication that authenticates the user based upon sending the login information to a bank server using a communications network and receiving confirmation from the bank server using the communications network;
a certificate component that generates a signed certificate based on the PIN;
a security component that stores in protected memory a security key associated with the client device wherein the security component further generates an encrypted banking request based on the security key and the banking request; and
a bank operation component that sends the encrypted banking request and the signed certificate to the bank server using the communications network.

10. The client device of claim 9, wherein the bank operation component further receives an encrypted banking operation result.

11. The client device of claim 10, wherein the security component further generates a decrypted banking operation result based on encrypted banking operation result and the security key.

12. The client device of claim 11, wherein the display component further displays the decrypted banking operation result.

13. A method, comprising:
receiving, by at least one computing device including at least one processor, login information from a client device associated with a customer;
verifying the login information received from the client device is accurate;
establishing a secure session with the client device;
receiving a personal identification number (“PIN”) from the customer;
decrypting a security key associated with the client device based on the PIN;
signing a banking operation request with the security key;
receiving a certificate from a certificate authority in response to sending a certificate request to the certificate authority;
receiving a banking operation result from a bank processing center in response to sending the banking operation request to the bank processing center;
generating an encrypted banking operation result based on the banking operation result; and
sending the encrypted banking operation result to the client device.

14. The method of claim 13, wherein the establishing the secure session includes establishing the secure session based upon a random number.

15. The method of claim 13, wherein the generating the encrypted banking operation result includes generating the encrypted banking operation result based upon a symmetric key.

16. The method of claim 15, further comprising:
decrypting the encrypted banking operation result based upon the symmetric key; and
displaying the banking operation result to the customer using the client device.

17. The method of claim 13, further comprising:
sending the PIN to the certificate authority.

18. A computer-readable storage medium comprising computer-executable instructions that, in response to execution, cause a computing system to perform operations, comprising:
receiving login information from a client device associated with a customer;
verifying the login information received from the client device is authentic with respect to a user;
in response to the verifying, establishing a secure session with the client device;
receiving a one time password from the client device;
verifying the one time password; and
receiving a certificate from a certificate authority in response to sending a certificate request to the certificate authority.

19. The computer readable storage medium of claim 18, wherein the establishing the secure session includes establishing the secure session based upon a random number.

20. The computer readable storage medium of claim 18, further comprising:
generating an encrypted certificate based on the certificate;
sending the encrypted certificate to the client device;
receiving a personal identification number (“PIN) from the customer in response to requesting the PIN from the customer;
generating an encrypted security key; and
saving the encrypted security key in a memory of the client device.
